(19) United States
(12) Patent Application Publication
(10) Pub. No.: US 2026/0244077 A1
(43) Pub. Date: Aug. 20, 2026

(54) IMAGE STABILIZATION MOTOR

(71) Applicant: Chipsemi Semiconductor (NingBo) Co., Ltd., Ningbo (CN)

(72) Inventors: Yulin ZHANG, Ningbo (CN); Jun ZOU, Ningbo (CN); Bo NIE, Ningbo (CN)

(21) Appl. No.: 19/309,539

(22) Filed: Aug. 25, 2025

Related U.S. Application Data
(63) Continuation of application No. PCT/CN2025/099058, filed on Jun. 4, 2025.

(30) Foreign Application Priority Data
Feb. 18, 2025 (CN) 202510180025.2

(51) Int. Cl. G03B 5/04

(52) U.S. Cl. CPC G03B 5/04; G03B 2205/0015

(57) ABSTRACT

An image stabilization motor includes a base, a first mover, a second mover, a circuit board, a first floating electrode plate, a second floating electrode plate, and two third floating electrode plates. The circuit board includes a first electrode plate and two second electrode plates. The first floating electrode plate includes a first part and a second part. The first part forms a first sub-capacitor with the first electrode plate. The second floating electrode plate includes a fourth part and a fifth part. The fourth part forms a second sub-capacitor with the second part. Each of the two third floating electrode plates including a seventh part and an eighth part. The eighth part forms a third sub-capacitor with the fifth part, and the seventh parts form two fourth sub-capacitors with the two second electrode plates, respectively.

### CROSS REFERENCE TO RELATED APPLICATIONS

The present application a continuation of PCT Patent Application No. Pct/cn 2025/099058, Entitled “image Stabilization Motor,” Filed on June 4, 2025, which claims the benefit of priority to Chinese Patent Application No. 2025101800252, titled “IMAGE STABILIZATION MOTOR”, filed on Feb. 18, 2025, the entire disclosure of which is incorporated herein by reference in its entirety.

### TECHNICAL FIELD

The present application relates to the technical field of camera devices, and in particular, to an image stabilization motor.

### BACKGROUND

To improve the image quality of camera devices during shooting, optical image stabilization technology can be employed within the camera device to provide motion compensation for the device's own jitter. During motion compensation, a gyroscope within the image stabilization motor of the camera device is typically used to detect jitter. The image stabilization motor then moves the lens in the opposite direction to compensate for image blurring caused by jitter.

To achieve focusing quickly and stably, most camera modules in current camera devices typically adopt a closed-loop control method. During the focusing process, the real-time position of the mover in the focusing motor is detected. Based on the detected position of the mover, the driving current moving the lens is adjusted so that the mover can rapidly reach the accurate focus position. When detecting the real-time position of the mover, Hall sensors and corresponding sensing magnets are commonly used.

However, the real-time position detection of the mover is inaccurate in the conventional technology.

### SUMMARY

Embodiments of the present disclosure provide an image stabilization motor, which is at least beneficial for improving the accuracy of real-time position detection of the mover.

In one aspect of the embodiments of the present disclosure, some embodiments of the present disclosure provide an image stabilization motor including: a base; a first mover suspended over the base, the first mover being movable relative to the base along a third direction in a reciprocating manner, the third direction being perpendicular to a bottom surface of the base; a second mover suspended over the first mover, the second mover being movable relative to the first mover along a first direction and a second direction in a reciprocating manner, where when the first mover moves relative to the base along the third direction in a reciprocating manner, the first mover drives the second mover to move along the third direction in a reciprocating manner, and the first direction and the second direction intersect with each other and are both parallel to the bottom surface of the base; a circuit board fixed to the base and surrounding the first mover, the circuit board including a first electrode plate and two second electrode plates, the first electrode plate and the second electrode plates being connected to a detection circuit; a first floating electrode plate on the first mover, the first floating electrode plate including a first part and a second part electrically connected to each other, the first part being on a first sidewall of the first mover and forming a first sub-capacitor with the first electrode plate, the second part being on a bottom surface of the first mover; a second floating electrode plate on the second mover, the second floating electrode plate including a fourth part and a fifth part electrically connected to each other, both the fourth part and the fifth part being on a bottom surface of the second mover, the fourth part forming a second sub-capacitor with the second part; two third floating electrode plates on the first mover, each of the two third floating electrode plates including a seventh part and an eighth part electrically connected to each other, the seventh part being on a second sidewall of the first mover, the eighth part being on the bottom surface of the first mover, the eighth part of any one of the two third floating electrode plates forming a third sub-capacitor with the fifth part, the seventh parts of the two third floating electrode plates forming two fourth sub-capacitors with the two second electrode plates, respectively; where the first sub-capacitor, the second sub-capacitor, the third sub-capacitor, and the corresponding fourth sub-capacitor are connected in series to provide a capacitance between the first electrode plate and a respective one of the two second electrode plates, and during reciprocating movement of the second mover relative to the first mover along the second direction, capacitance values of the first sub-capacitor, the second sub-capacitor, and the fourth sub-capacitors remain constant, while a capacitance value of the third sub-capacitor varies accordingly.

In some embodiments, a length of the first electrode plate along the third direction is greater than a length of the first part along the third direction.

In some embodiments, an orthographic projection of the second part onto the bottom surface of the base covers an orthographic projection of the fourth part onto the bottom surface of the base; or, the orthographic projection of the fourth part onto the bottom surface of the base covers the orthographic projection of the second part onto the bottom surface of the base.

In some embodiments, the eighth parts of the two third floating electrode plates are arranged along a second direction.

In some embodiments, the circuit board further includes two third electrode plates connected to the detection circuit; the second floating electrode plate further includes a sixth part electrically connected to the fourth part and the fifth part, the sixth part being on the bottom surface of the second mover; the image stabilization motor further includes two fourth floating electrode plates on the first mover, each of the two fourth floating electrode plates including a ninth part and a tenth part electrically connected to each other, the ninth part being on the second sidewall of the first mover, the tenth part being on the bottom surface of the first mover, the tenth part of any one of the two fourth floating electrode plates forming a fifth sub-capacitor with the sixth part, the ninth parts of the two fourth floating electrode plates forming two sixth sub-capacitors with the two third electrode plates, respectively; where the first sub-capacitor, the second sub-capacitor, the fifth sub-capacitor, and the corresponding sixth sub-capacitor are connected in series to provide a capacitance between the first electrode plate and a respective one of the two third electrode plates, and during the reciprocating movement of the second mover relative to the first mover along the first direction, capacitance values of the first sub-capacitor, the second sub-capacitor, and the sixth sub-capacitors remain constant, while a capacitance value of the fifth sub-capacitor varies accordingly.

In some embodiments, the tenth parts of the two fourth floating electrode plates are arranged along the first direction.

In some embodiments, the two second electrode plates are on a surface of the circuit board along the first direction, and the two third electrode plates are on a surface of the circuit board along the second direction.

In some embodiments, the circuit board further includes two fourth electrode plates connected to the detection circuit; the first floating electrode plate further includes a third part electrically connected to the first part and the second part, the third part being on the first sidewall of the first mover, the third part forming a seventh sub-capacitor with any one of the two fourth electrode plates; where the first sub-capacitor, and the corresponding seventh sub-capacitor are connected in series to provide a capacitance between the first electrode plate and a respective one of the two fourth electrode plates, and during the reciprocating movement of the first mover relative to the base along the third direction, the capacitance value of the first sub-capacitor remains constant, while a capacitance value of the seventh sub-capacitor varies accordingly.

In some embodiments, along the third direction, a width of each of the two fourth electrode plates is less than or equal to a width of the third part.

In some embodiments, along the third direction, a spacing between the two fourth electrode plates is less than the width of the third part.

The technical solution provided in the embodiments of the present disclosure has at least the following advantages.

In the image stabilization motor provided by the embodiments of the present disclosure, the first electrode plate and the two second electrode plates are configured to connect to the detection circuit. The first sub-capacitor, the second sub-capacitor, the third sub-capacitor, and the corresponding fourth sub-capacitor are connected in series to provide a capacitance between the first electrode plate and a respective one of the two second electrode plates. The first sub-capacitor is formed by the first electrode plate and the first part of the first floating electrode plate opposing each other. The second sub-capacitor is formed by the fourth part of the second floating electrode plate and the second part of the first floating electrode plate opposing each other. The third sub-capacitor is formed by the eighth part of the third floating electrode plate and the fifth part of the second floating electrode plate opposing each other. The respective fourth sub-capacitor is formed by the seventh part of the third floating electrode plate and the corresponding second electrode plate opposing each other. During the reciprocating movement of the second mover relative to the first mover along the second direction, since the capacitance values of the first sub-capacitor, the second sub-capacitor, and the respective fourth sub-capacitor all remain constant, and only the capacitance value of the third sub-capacitor varies, the change in capacitance value between the first electrode plate and a respective one of the two second electrode plates exhibits a linear relationship with a movement displacement of the second mover relative to the base along the second direction. Based on the capacitance value between the first electrode plate and the respective second electrode plate, the positional change of the second mover relative to the base can be obtained. Subsequently, the position of the second mover is adjusted via a driving mechanism to compensate for the displacement caused by jitter, thereby improving the image stabilization accuracy of the image stabilization motor. Since both the first electrode plate and the two second electrode plates are located on the circuit board, and the circuit board is fixed to the base, the detection circuit of the first electrode plate and the two second electrode plates does not need to be connected to any mover. Therefore, the detection circuit is not affected by the movement of the first mover or the second mover, which is beneficial for improving the accuracy of detecting the real-time position of the mover. Consequently, the accuracy of the driving signals generated by the driving mechanism is improved, and the image stabilization accuracy of the image stabilization motor is enhanced.

### BRIEF DESCRIPTION OF THE DRAWINGS

One or more embodiments are illustrated through the figures in the corresponding drawings. These exemplary illustrations do not constitute limitations on the embodiments unless otherwise stated. The figures in the accompanying drawings do not constitute a scale limitation. In order to illustrate the technical solutions in the embodiments of the present disclosure or in the conventional technology more clearly, the drawings used in the following description of the embodiments are briefly described below. It is apparent that the drawings in the following description show only some embodiments of the present disclosure, and other drawings may be obtained by those of ordinary skill in the art based on these drawings without any creative efforts.

FIG. 1 is an exploded view of the image stabilization motor provided by an embodiment of the present disclosure from one perspective;

FIG. 2 is an exploded view of the image stabilization motor provided by an embodiment of the present disclosure another perspective;

FIG. 3 is a top view of the electrode plates relative to a bottom surface of the base, provided by an embodiment of the present disclosure;

FIG. 4 is a schematic structural diagram of the electrode plates, provided by an embodiment of the present disclosure; and

FIG. 5A and FIG. 5B are schematic diagrams showing two types of orthographic projections of the eighth part and the fifth part onto the bottom surface of the base, provided by an embodiment of the present disclosure.

### DETAILED DESCRIPTION OF THE EMBODIMENTS

As is known from the background section, the real-time position detection of the mover is inaccurate in the conventional technology.

Embodiments of the present disclosure provide an image stabilization motor, which is at least beneficial for improving the accuracy of real-time position detection of the mover.

In the description of the embodiments of the present disclosure, technical terms such as “first”, “second”, etc., are merely used for distinguishing different objects and should not be understood as indicating or implying relative importance or implicitly specifying the number, specific order, or priority of the indicated technical features.

In the description of the embodiments of the present disclosure, the term “plurality/plural/multiple” refers to two or more, unless otherwise explicitly specified.

The mention of “embodiment” in this paper means that the specific features, structures, or characteristics described in conjunction with the embodiments may be included in at least one embodiment of the present disclosure. The appearance of this phrase at various locations in the specification does not necessarily refer to the same embodiment, nor is it an independent or alternative embodiment that is exclusive with other embodiments. Those skilled in the art can understand explicitly and implicitly that the embodiments described in this paper can be combined with other embodiments.

In the description of the embodiments of the present disclosure, the term “and/or” merely describes the associative relationship between associated objects, indicating that there can be three types of relationships. For example, A and/or B can represent three possible situations: sole existence of A, existence of both A and B, and sole existence of B. Additionally, the character “/” in this paper generally indicates that the associated objects with this character are in an “or” relationship.

In the description of the embodiments of the present disclosure, the technical terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc., indicate the orientation or positional relationship based on the orientation or positional relationship shown in the accompanying drawings. This is solely for the purpose of facilitating the description of the embodiments of the present disclosure and simplifying the description, and in no way indicate or imply that the devices or elements referred to must have a specific orientation, be constructed or operated in a specific orientation. Therefore, these terms should not be construed as a limitation on the embodiments of the present disclosure.

In the description of the embodiments of the present disclosure, unless otherwise explicitly specified and defined, the technical terms such as “installation”, “connection”, “fixation”, etc. should be understood in a broad sense. For example, “connection” may refer to fixed connection, detachable connection, or integral connection; mechanical connection or electrical connection; direct connection, or indirect connection through an intermediary. It may further refer to the internal connectivity between two components or the interaction between two components. For those of ordinary skill in the art, the specific meanings of the above terms in embodiments of the present disclosure should be understood according to the specific circumstances.

In the description of the embodiments of the present disclosure, when it recites that one component “includes” another component, it does not exclude other components and other components may also be further included unless otherwise stated.

The terms used in the description of various embodiments mentioned in this paper are solely for the purpose of describing specific embodiments and are not intended to be restrictive. As used in the description of the various embodiments and the appended claims, “component” is also intended to cover the plural form, unless the context clearly indicates otherwise.

The following provides a detailed description of the various embodiments of the present disclosure in conjunction with the accompanying drawings. However, those of ordinary skill in the art may understand that in various embodiments of the present disclosure, many technical details have been presented to facilitate a better understanding of the present disclosure by the reader. However, even without these technical details and the various variations and modifications based on the following embodiments, the technical solution claimed in the present disclosure can still be achieved.

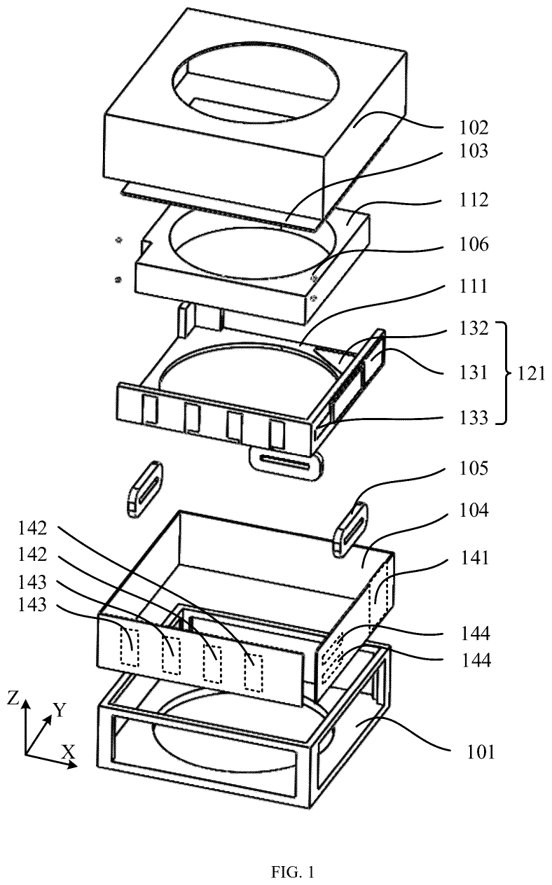

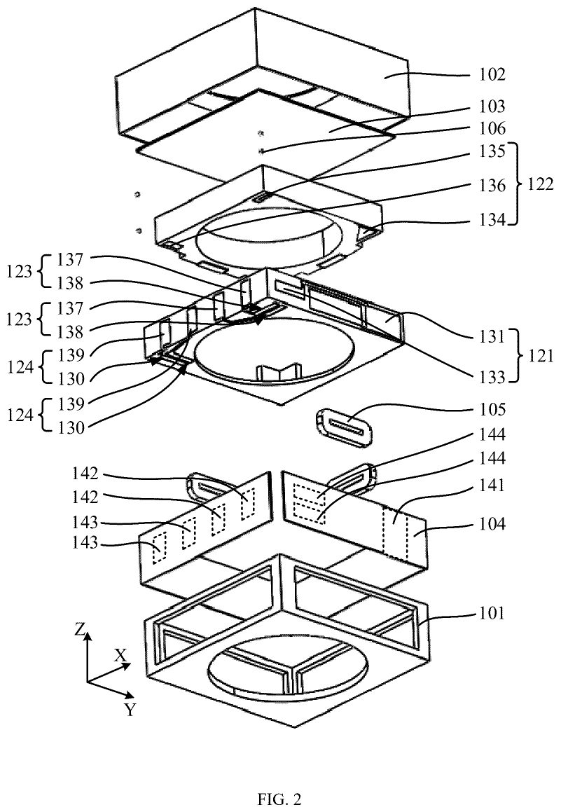

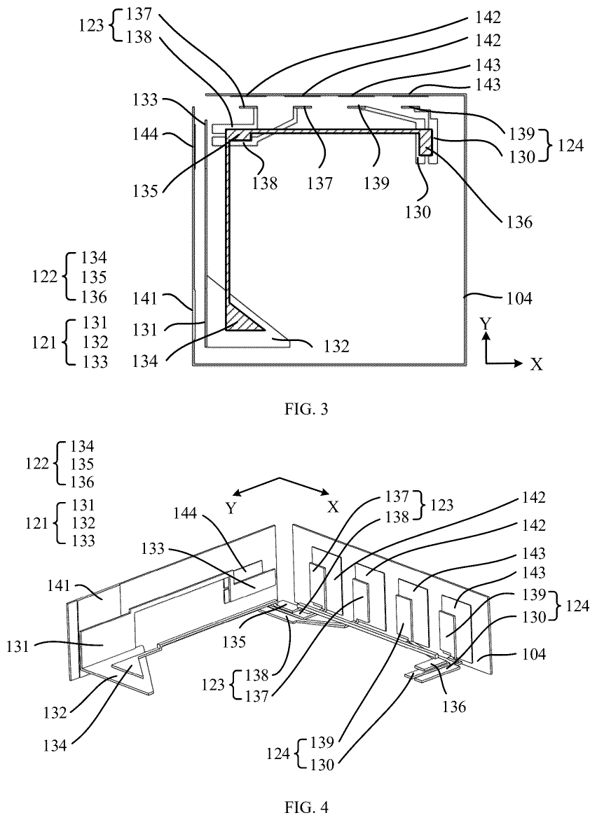

FIG. 1 is an exploded view of the image stabilization motor provided by an embodiment of the present disclosure from one perspective; FIG. 2 is an exploded view of the image stabilization motor provided by an embodiment of the present disclosure another perspective; FIG. 3 is a top view of the electrode plates relative to a bottom surface of the base, provided by an embodiment of the present disclosure; FIG. 4 is a schematic structural diagram of the electrode plates, provided by an embodiment of the present disclosure. In FIG. 1 and FIG. 2, the positions corresponding to the first electrode plate, the second electrode plates, the third electrode plates, and the fourth electrode plates are all indicated by dashed-line boxes. In FIG. 4, for clarity of presentation, only the side surface of the circuit board provided with the first electrode plate and the third electrode plates and the side surface provided with the second electrode plates and the third electrode plates are shown, while the other two side surfaces are not shown.

Referring to FIGS. 1 to 4, embodiments of the present disclosure provide an image stabilization motor including: a base 101, a first mover 111, a second mover 112, a circuit board 104, a first floating electrode plate 121, a second floating electrode plate 122, and a third floating electrode plate 123.

The first mover 111 is suspended over the base 101. The first mover 111 is movable relative to the base 101 along a third direction Z in a reciprocating manner, and the third direction Z is perpendicular to a bottom surface of the base 101.

The second mover 112 is suspended over the first mover 111. The second mover 112 is movable relative to the first mover 111 along a first direction X and a second direction Y in a reciprocating manner. When the first mover 111 moves relative to the base 101 along the third direction Z in a reciprocating manner, the first mover 111 drives the second mover 112 to move along the third direction Z in a reciprocating manner, and the first direction X and the second direction Y intersect with each other and are both parallel to the bottom surface of the base 101.

The circuit board 104 is fixed to the base 101 and surrounds the first mover 111. The circuit board 104 includes a first electrode plate 141 and two second electrode plates 142. The first electrode plate 141 and the second electrode plates 142 are connected to a detection circuit (not shown).

The first floating electrode plate 121 is located on the first mover 111. The first floating electrode plate 121 includes a first part 131 and a second part 132 electrically connected to each other. The first part 131 is located on a first sidewall of the first mover 111 and opposes the first electrode plate 141, and together with the first electrode plate 141 forms a first sub-capacitor. The second part 132 is located on a bottom surface of the first mover 111.

The second floating electrode plate 122 is located on the second mover 112. The second floating electrode plate 122 includes a fourth part 134 and a fifth part 135 electrically connected to each other. Both the fourth part 134 and the fifth part 135 are located on a bottom surface of the second mover 112. The fourth part 134 opposes the second part 132, and together with the second part 132 forms a second sub-capacitor.

The number of third floating electrode plates 123 is two. The third floating electrode plates 123 are located on the first mover 111. Each of the two third floating electrode plates 123 includes a seventh part 137 and an eighth part 138 electrically connected to each other. The seventh part 137 is located on a second sidewall of the first mover 111, and the eighth part 138 is located on the bottom surface of the first mover 111. The eighth part 138 of any one of the third floating electrode plates 123 opposes the fifth part 135 of the second floating electrode plate 122, and together with the fifth part 135 forms a third sub-capacitor. The seventh parts 137 of two third floating electrode plates 123 form two fourth sub-capacitors with the two second electrode plates 142, respectively.

The first sub-capacitor, the second sub-capacitor, the third sub-capacitor, and the corresponding fourth sub-capacitor are connected in series to provide a capacitance between the first electrode plate 141 and a respective one of the two second electrode plates 142. During reciprocating movement of the second mover 112 relative to the first mover 111 along the second direction Y, capacitance values of the first sub-capacitor, the second sub-capacitor, and the fourth sub-capacitors remain constant, while a capacitance value of the third sub-capacitor varies accordingly.

In the image stabilization motor provided by the embodiments of the present disclosure, the second mover 112 is configured to hold the lens. The first mover 111 moves relative to the base 101 along the third direction Z in a reciprocating manner to drive the second mover to move along the third direction Z, thereby driving the lens to move along the optical axis direction to achieve focusing of the lens. The second mover 112 moves relative to the first mover 111 along the first direction X or the second direction Y, to achieve two-axis image stabilization of the lens along directions perpendicular to the optical axis. The first electrode plate 141 and the two second electrode plates 142 are configured to connect to the detection circuit. The first sub-capacitor, the second sub-capacitor, the third sub-capacitor, and the corresponding fourth sub-capacitor are connected in series to provide a capacitance between the first electrode plate 141 and a respective one of the two second electrode plates 142. The first sub-capacitor is formed by the first electrode plate 141 and the first part 131 of the first floating electrode plate 121 opposing each other. The second sub-capacitor is formed by the fourth part 134 of the second floating electrode plate 122 and the second part 132 of the first floating electrode plate 121 opposing each other. The third sub-capacitor is formed by the eighth part 138 of the third floating electrode plate 123 and the fifth part 135 of the second floating electrode plate 122 opposing each other. The respective fourth sub-capacitor is formed by the seventh part 137 of the third floating electrode plate 123 and the corresponding second electrode plate 142 opposing each other. During the reciprocating movement of the second mover 112 relative to the first mover 111 along the second direction Y, the first mover 111 undergoes a displacement relative to the second mover 112 along the second direction Y. Since the second mover 112 can only move relative to the base 101 along the third direction Z in a reciprocating manner, no relative displacement occurs between the second mover 112 and the base 101 in either the first direction X or the second direction Y. Therefore, the displacement of the second mover 112 relative to the first mover 111 along the second direction Y is equivalent to the relative displacement of the second mover 112 with respect to the base 101 along the second direction Y. During the reciprocating movement of the second mover 112 relative to the first mover 111 along the second direction Y, since the capacitance values of the first sub-capacitor, the second sub-capacitor, and the respective fourth sub-capacitor all remain constant, and only the capacitance value of the third sub-capacitor varies, the change in capacitance value between the first electrode plate 141 and a respective one of the two second electrode plates 142 exhibits a linear relationship with a movement displacement of the second mover 112 relative to the base 101 along the second direction Y. Based on the capacitance value between the first electrode plate 141 and the respective second electrode plate 142, the positional change of the second mover 112 relative to the base 101 can be obtained. Subsequently, the position of the second mover 112 is adjusted via a driving mechanism to compensate for the displacement caused by jitter, thereby improving the image stabilization accuracy of the image stabilization motor. Since both the first electrode plate 141 and the two second electrode plates 142 are located on the circuit board 104, and the circuit board 104 is fixed to the base 101, the detection circuit of the first electrode plate 141 and the two second electrode plates 142 does not need to be connected to any mover. Therefore, the detection circuit is not affected by the movement of the first mover 111 or the second mover 112, which is beneficial for improving the accuracy of detecting the real-time displacement of the mover. Consequently, the accuracy of the driving signals generated by the driving mechanism is improved, and the image stabilization accuracy of the image stabilization motor is enhanced.

Referring to FIG. 1 and FIG. 2, the image stabilization motor further includes an upper cover 102 and a pressure plate 103. The upper cover 102 and the base 101 together define an accommodation cavity. The first mover 111, the second mover 112, and the circuit board 104 are all accommodated within the accommodation cavity. The pressure plate 103 can serve a protective function, preventing damage to or contamination of internal components of the image stabilization motor.

The image stabilization motor also includes a plurality of balls 106. Balls 106 are disposed between the first mover 111 and the base 101 to enable the movement of the first mover 111 relative to the base 101 along the third direction Z. Balls 106 are disposed between the bottom of the second mover 112 and the first mover 111 to enable the movement of the second mover 112 relative to the first mover 111 along the first direction X or the second direction Y.

The image stabilization motor is further provided with a plurality of magnets 105. Correspondingly, the circuit board 104 is provided with driving coils (not shown in the figures). The magnets 105 and the driving coils form a driving mechanism. Magnets 105 fixed on the sidewalls of the first mover 111 and the corresponding driving coils are used to drive the movement of the first mover 111 relative to the base 101 along the third direction Z. Magnets 105 fixed on sidewalls of the second mover 112 along the first direction X and magnets 105 fixed on sidewalls along the second direction Y, together with their respectively corresponding driving coils, are used to drive the movement of the second mover 112 relative to the first mover 111 along the first direction X or the second direction Y.

The circuit board 104 further includes two third electrode plates 143 connected to the detection circuit. The second floating electrode plate 122 further includes a sixth part 136 electrically connected to the fourth part 134 and the fifth part 135. The sixth part 136 is located on the bottom surface of the second mover 112. The image stabilization motor further includes two fourth floating electrode plates 124. The two fourth floating electrode plates 124 are located on the first mover 111. Each of the two fourth floating electrode plates 124 includes a ninth part 139 and a tenth part 130 electrically connected to each other. The ninth part 139 is located on the second sidewall of the first mover 111. The tenth part 130 is located on the bottom surface of the first mover 111. The tenth part 130 of any one of the two fourth floating electrode plates 124 opposes the sixth part 136 of the second floating electrode plate 122, and together with the sixth part 136 of the second floating electrode plate 122 forms a fifth sub-capacitor. The ninth parts 139 of the two fourth floating electrode plates 124 form two sixth sub-capacitors with the two third electrode plates 143, respectively.

The first sub-capacitor, the second sub-capacitor, the fifth sub-capacitor, and the corresponding sixth sub-capacitor are connected in series to provide a capacitance between the first electrode plate 141 and a respective one of the two third electrode plates 143. During the reciprocating movement of the second mover 112 relative to the first mover 111 along the first direction X, capacitance values of the first sub-capacitor, the second sub-capacitor, and the sixth sub-capacitors remain constant, while a capacitance value of the fifth sub-capacitor varies accordingly.

During the reciprocating movement of the second mover 112 relative to the first mover 111 along the first direction X, the first mover 111 undergoes a displacement relative to the second mover 112 along the first direction X. Since the second mover 112 can only move relative to the base 101 along the third direction Z in a reciprocating manner, no relative displacement occurs between the second mover 112 and the base 101 in either the first direction X or the second direction Y. Therefore, the displacement of the second mover 112 relative to the first mover 111 along the first direction X is equivalent to the relative displacement of the second mover 112 with respect to the base 101 along the first direction X. During the reciprocating movement of the second mover 112 relative to the first mover 111 along the first direction X, since the capacitance values of the first sub-capacitor, the second sub-capacitor, and the respective sixth sub-capacitor all remain constant, and only the capacitance value of the fifth sub-capacitor varies, the change in capacitance value between the first electrode plate 141 and a respective one of the two third electrode plates 143 exhibits a linear relationship with a movement displacement of the respective second mover 112 relative to the base 101 along the first direction X. Based on the capacitance value between the first electrode plate 141 and the respective third electrode plate 143, the positional change of the second mover 112 relative to the base 101 can be obtained. Subsequently, the position of the second mover 112 is adjusted via a driving mechanism to compensate for the displacement caused by jitter, thereby improving the image stabilization accuracy of the image stabilization motor.

The circuit board 104 further includes two fourth electrode plates 144 connected to the detection circuit. The first floating electrode plate 121 further includes a third part 133 electrically connected to the first part 131 and the second part 132. The third part 133 is located on the first sidewall of the first mover 111. The third part 133 forms a seventh sub-capacitor with any one of the two fourth electrode plates 144. The first sub-capacitor, and the corresponding seventh sub-capacitor are connected in series to provide a capacitance between the first electrode plate 141 and a respective one of the two fourth electrode plates 144. During the reciprocating movement of the first mover 111 relative to the base 101 along the third direction Z, the capacitance value of the first sub-capacitor remains constant, while a capacitance value of the seventh sub-capacitor varies accordingly. As such, the change in capacitance value between the first electrode plate 141 and a respective one of the two fourth electrode plates 144 exhibits a linear relationship with a movement displacement of the first mover 111 relative to the base 101 along the third direction Z. Based on the capacitance value between the first electrode plate 141 and the respective fourth electrode plate 144, the positional change of the first mover 111 relative to the base 101 can be obtained. Subsequently, the position of the first mover 111 is adjusted via the driving mechanism to compensate for the displacement caused by jitter, thereby improving the image stabilization accuracy of the image stabilization motor.

In some embodiments, a length of the first electrode plate 141 along the third direction Z is greater than a length of the first part 131 along the third direction Z. The effective area available for charge storage between the first electrode plate 141 and the first part 131 constitutes the effective area of the first sub-capacitor. The effective area is the overlapping area between the orthographic projection of the first electrode plate 141 onto a side surface of the circuit board 104 and the orthographic projection of the first part 131 onto the same side surface of the circuit board 104. Since the first mover 111 can only move relative to the base 101 along the third direction Z, the length of the first electrode plate 141 along the third direction Z is greater than the length of the first part 131 along the third direction Z. This configuration is beneficial for ensuring that during the movement of the first mover 111 relative to the base 101 along the third direction Z, the effective area of the first sub-capacitor does not change due to the first part 131 extending beyond the first electrode plate 141, and the capacitance value of the first sub-capacitor therefore does not change either.

It should be noted that, in this embodiment, the shapes of the first electrode plate 141 and the first part 131 are both exemplified as rectangles. This does not constitute a limitation on the shapes of the first electrode plate 141 and the first part 131. In other embodiments, the shape of the first electrode plate and the shape of the first part may also be circular, triangular, trapezoidal, polygonal, etc., as long as the effective area between the first electrode plate and the first part remains unchanged and the capacitance value of the first sub-capacitor remains unchanged while the first mover moves relative to the base along the third direction.

In some embodiments, an orthographic projection of the second part 132 onto the bottom surface of the base 101 covers an orthographic projection of the fourth part 134 onto the bottom surface of the base 101. In some other embodiments, an orthographic projection of the fourth part onto the bottom surface of the base covers an orthographic projection of the second part onto the bottom surface of the base.

The effective area available for charge storage between the second part 132 and the fourth part 134 constitutes the effective area of the second sub-capacitor. The effective area is the overlapping area between the orthographic projection of the second part 132 onto the bottom surface of the base 101 and the orthographic projection of the fourth part 134 onto the bottom surface of the base 101. Since the second mover 112 can only move relative to the first mover 111 along the first direction X or the second direction Y, the spacing between the second part 132 and the fourth part 134 does not change. When the orthographic projection of the second part 132 onto the bottom surface of the base 101 covers the orthographic projection of the fourth part 134 onto the bottom surface of the base 101, or when the orthographic projection of the fourth part 134 onto the bottom surface of the base covers the orthographic projection of the second part onto the bottom surface of the base, the effective area of the second sub-capacitor does not change, and the capacitance value of the second sub-capacitor therefore does not change either, during the movement of the second mover 112 relative to the first mover 111 along the first direction X or the second direction Y.

It should be noted that, in this embodiment, the shapes of the second part 132 and the fourth part 134 are both exemplified as rectangles. This does not constitute a limitation on the shapes of the second part 132 and the fourth part 134. In other embodiments, the shape of the second part and the shape of the fourth part may also be circular, triangular, trapezoidal, polygonal, etc., as long as the effective area between the second part and the fourth part remains unchanged and the capacitance value of the second sub-capacitor remains unchanged while the second mover moves relative to the first mover along the first direction or the second direction.

In this embodiment, the eighth parts 138 of the two third floating electrode plates 123 are arranged along the second direction Y. In other embodiments, the angle between the arrangement direction of the eighth parts of the two third floating electrode plates and the second direction may be greater than 0° and less than 90°, for example, 30°, 45°, or 60°.

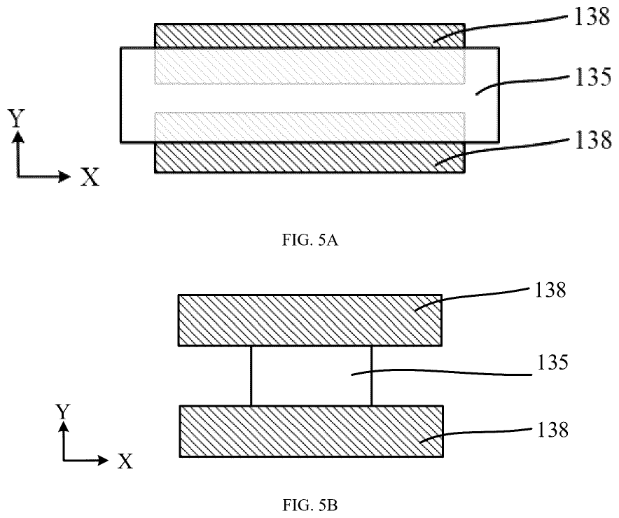

FIG. 5A and FIG. 5B are schematic diagrams showing two types of orthographic projections of the eighth part and the fifth part onto the bottom surface of the base, provided by an embodiment of the present disclosure. The fifth part is shown in a semitransparent state for clarity of illustration of the overlapping region between the eighth part and the fifth part.

The effective area available for charge storage between the eighth part 138 and the fifth part 135 constitutes the effective area of the third sub-capacitor. The effective area is the overlapping area between the orthographic projection of the eighth part 138 onto the bottom surface of the base 101 and the orthographic projection of the fifth part 135 onto the bottom surface of the base 101. Referring to FIG. 5A and FIG. 5B, the eighth parts 138 of the two third floating electrode plates 123 are arranged along the second direction Y. When the second mover 112 moves relative to the first mover 111 along the second direction Y, the effective area between the fifth part 135 and the eighth part 138 of any one of the third floating electrode plates 123 changes, resulting in a change in the capacitance value of the corresponding third sub-capacitor.

Referring to FIG. 5A, the length of the fifth part 135 along the first direction X may be greater than the length of the eighth part 138 along the first direction X; or, referring to FIG. 5B, the length of the fifth part 135 along the first direction X may be less than the length of the eighth part 138 along the first direction X; or, the length of the fifth part along the first direction may also be equal to the length of the eighth part along the first direction. Referring to FIG. 5A, the length of the fifth part 135 along the second direction Y may be greater than the spacing between the eighth parts 138 of the two third floating electrode plates; or, referring to FIG. 5B, the length of the fifth part 135 along the second direction Y may be equal to the spacing between the eighth parts 138 of the two third floating electrode plates; or, the length of the fifth part along the second direction may also be less than the spacing between the eighth parts of the two third floating electrode plates.

It should be noted that the size and shape of the fifth part 135 and the size and shape of the eighth part 138 can be adjusted according to actual requirements, as long as during the movement of the second mover 112 relative to the first mover 111 along the second direction Y, the effective area between the fifth part 135 and the eighth part 138 of any one of the third floating electrode plates 123 varies, and the capacitance value of the third sub-capacitor varies accordingly.

The effective area available for charge storage between the seventh part 137 of the third floating electrode plate 123 and the second electrode plate 142 constitutes the effective area of the fourth sub-capacitor. The effective area is the overlapping area between the orthographic projection of the second electrode plate 142 onto a side surface of the circuit board 104 and the orthographic projection of the seventh part 137 onto the same side surface of the circuit board 104. The shape and size of the second electrode plate 142 and the shape and size of the seventh part 137 can be adjusted according to actual requirements, as long as during the movement of the first mover 111 relative to the base 101 along the third direction Z, the effective area between the seventh part 137 and the second electrode plate 142 remains constant, and the capacitance value of the fourth sub-capacitor also remains constant. Specific settings can refer to the aforementioned first electrode plate 141 and first part 131, and details are not repeated here.

In this embodiment, the tenth parts 130 of the two fourth floating electrode plates 124 are arranged along the first direction X. In other embodiments, the angle between the arrangement direction of the tenth parts of the two fourth floating electrode plates and the first direction may be greater than 0° and less than 90°, for example, 30°, 45°, or 60°.

The effective area available for charge storage between the tenth part 130 and the sixth part 136 constitutes the effective area of the fifth third sub-capacitor. The effective area is the overlapping area between the orthographic projection of the tenth part 130 onto the bottom surface of the base 101 and the orthographic projection of the sixth part 136 onto the bottom surface of the base 101. The size and shape of the sixth part 136 and the size and shape of the tenth part 130 can be adjusted according to actual requirements, as long as during the movement of the second mover 112 relative to the first mover 111 along the first direction X, the effective area between the sixth part 136 and the tenth part 130 of any one of the fourth floating electrode plates 124 varies, and the capacitance value of the fifth sub-capacitor varies accordingly. The size and shape of the sixth part 136 and the size and shape of the tenth part 130 can refer to the aforementioned fifth part 135 and eighth part 138, and details are not repeated here.

The effective area available for charge storage between the ninth part 139 and the third electrode plate 143 constitutes the effective area of the sixth sub-capacitor. The effective area is the overlapping area between the orthographic projection of the ninth part 139 onto a side surface of the circuit board 104 and the orthographic projection of the third electrode plate 143 onto the same side surface of the circuit board 104. The shape and size of the third electrode plate 143 and the shape and size of the ninth part 139 can be adjusted according to actual requirements, as long as during the movement of the first mover 111 relative to the base 101 along the third direction Z, the effective area between the third electrode plate 143 and the ninth part 139 remains constant, and the capacitance value of the sixth sub-capacitor also remains constant. Specific settings can refer to the aforementioned first electrode plate 141 and first part 131, and details are not repeated here.

The effective area available for charge storage between the third part 133 and the fourth electrode plate 144 constitutes the effective area of the seventh sub-capacitor. The effective area is the overlapping area between the orthographic projection of the fourth electrode plate 144 onto a side surface of the circuit board 104 and the orthographic projection of the third part 133 onto the same side surface of the circuit board 104. The shape and size of the third part 133 and the shape and size of the fourth electrode plate 144 can be adjusted according to actual requirements, as long as during the movement of the first mover 111 relative to the base 101 along the third direction Z, the effective area between the third part 133 and the fourth electrode plate 144 remains constant, and the capacitance value of the seventh sub-capacitor also remains constant. Specific settings can refer to the aforementioned fifth part 135 and eighth part 138, and details are not repeated here.

In some embodiments, along the third direction Z, a width of each of the two fourth electrode plates 144 is less than or equal to a width of the third part 133. Thus, it can be ensured that an effective area is always maintained between the third part 133 and any one of the fourth electrode plates 144 during movement. This prevents abrupt changes in capacitance detection, thereby improving the accuracy of position detection and enhancing the image stabilization accuracy of the image stabilization motor.

In some embodiments, along the third direction Z, a spacing between the two fourth electrode plates 144 is less than the width of the third part 133. Thus, it can be avoided that when the third part 133 moves to between the two fourth electrode plates 144, neither of the two fourth electrode plates 144 can detect capacitance. This prevents abrupt changes in capacitance detection, thereby improving the accuracy of position detection and enhancing the image stabilization accuracy of the image stabilization motor.

In this embodiment, the second electrode plates 142 and the third electrode plates 143 are both located on the same surface of the circuit board 104 along the second direction Y. Such configuration is for illustration only. In some other embodiments, the two second electrode plates are on a surface of the circuit board along the first direction, and the two third electrode plates are on a surface of the circuit board along the second direction. Correspondingly, the position of the seventh part 137 of the third floating electrode plate 123, which forms the fourth sub-capacitor with the second electrode plate 142, can be adjusted based on the position of the second electrode plate 142. The position of the ninth part 139 of the fourth floating electrode plate 124, which forms the sixth sub-capacitor with the third electrode plate 143, can be adjusted based on the position of the third electrode plate 143.

In some embodiments, during the movement of the second mover 112 relative to the first mover 111 along the first direction X, the capacitance value of the third sub-capacitor may remain constant. Thus, the movement of the second mover 112 relative to the first mover 111 along the first direction X is linearly correlated only with the capacitance change of the fifth sub-capacitor. In some embodiments, during the movement of the second mover 112 relative to the first mover 111 along the first direction X, the capacitance value of the third sub-capacitor may vary. Thus, the movement of the second mover 112 relative to the first mover 111 along the first direction X is linearly correlated with capacitance changes of both the third sub-capacitor and the fifth sub-capacitor. By testing the combined capacitance values corresponding to multiple motion states of the second mover 112 relative to the first mover 111, the relative positional relationship between the second mover 112 and the first mover 111 can also be inversely derived. Similarly, during the movement of the second mover 112 relative to the first mover 111 along the second direction Y, the capacitance value of the fifth sub-capacitor may vary or remain constant.

It should be noted that, in the drawings provided in this embodiment, the shape and position of the electrical connection traces between the first part 131, the second part 132, and the third part 133 of the first floating electrode plate 121 are shown merely as examples. This does not constitute a limitation on the shape and position of the electrical connection traces between the first part 131, the second part 132, and the third part 133. The shape and position of the electrical connection traces between the first part 131, the second part 132, and the third part 133 can be adjusted according to actual requirements. Similarly, the shape and position of the electrical connection traces between the fourth part 134, the fifth part 135, and the sixth part 136 of the second floating electrode plate 122 can be adjusted according to actual requirements. The shape and position of the electrical connection traces between the seventh part 137 and the eighth part 138 of the third floating electrode plate 123 can be adjusted according to actual requirements. The shape and position of the electrical connection traces between the ninth part 139 and the tenth part 130 of the fourth floating electrode plate 124 can be adjusted according to actual requirements.

In the image stabilization motor of the embodiments of the present disclosure, the first electrode plate 141 and the two second electrode plates 142 are configured to connect to the detection circuit. The first sub-capacitor, the second sub-capacitor, the third sub-capacitor, and the corresponding fourth sub-capacitor are connected in series to provide a capacitance between the first electrode plate 141 and a respective one of the two second electrode plates 142. The first sub-capacitor is formed by the first electrode plate 141 and the first part 131 of the first floating electrode plate 121 opposing each other. The second sub-capacitor is formed by the fourth part 134 of the second floating electrode plate 122 and the second part 132 of the first floating electrode plate 121 opposing each other. The third sub-capacitor is formed by the eighth part 138 of the third floating electrode plate 123 and the fifth part 135 of the second floating electrode plate 122 opposing each other. The respective fourth sub-capacitor is formed by the seventh part 137 of the third floating electrode plate 123 and the corresponding second electrode plate 142 opposing each other. During the reciprocating movement of the second mover 112 relative to the first mover 111 along the second direction Y, since the capacitance values of the first sub-capacitor, the second sub-capacitor, and the respective fourth sub-capacitor all remain constant, and only the capacitance value of the third sub-capacitor varies, the change in capacitance value between the first electrode plate 141 and a respective one of the two second electrode plates 142 exhibits a linear relationship with a movement displacement of the second mover 112 relative to the base 101 along the second direction Y. Based on the capacitance value between the first electrode plate 141 and the respective second electrode plate 142, the positional change of the second mover 112 relative to the base 101 can be obtained. Subsequently, the position of the second mover 112 is adjusted via a driving mechanism to compensate for the displacement caused by jitter, thereby improving the image stabilization accuracy of the image stabilization motor. Since both the first electrode plate 141 and the two second electrode plates 142 are located on the circuit board 104, and the circuit board 104 is fixed to the base 101, the detection circuit of the first electrode plate 141 and the two second electrode plates 142 does not need to be connected to any mover. Therefore, the detection circuit is not affected by the movement of the first mover 111 or the second mover 112, which is beneficial for improving the accuracy of detecting the real-time displacement of the mover. Consequently, the accuracy of the driving signals generated by the driving mechanism is improved, and the image stabilization accuracy of the image stabilization motor is enhanced.

Those of ordinary skill in the art can understand that the aforementioned embodiments are specific examples for implementing the present disclosure. In practical applications, various modifications can be made to them in form and detail without deviating from the spirit and scope of the present disclosure. A person skilled in the art may make various alterations and modifications without departing from the spirit and scope of the present disclosure, and thus the scope of protection of the present disclosure should be determined by the scope of the appended claims.

What is claimed is

1. An image stabilization motor, comprising:
a base;
a first mover suspended over the base;
a second mover suspended over the first mover, the second mover being movable relative to the first mover along a first direction and a second direction in a reciprocating manner, wherein when the first mover moves relative to the base along a third direction in a reciprocating manner, the third direction being perpendicular to a bottom surface of the base, the first mover drives the second mover to move along the third direction in a reciprocating manner, and the first direction and the second direction intersect with each other and are both parallel to the bottom surface of the base;
a circuit board fixed to the base and surrounding the first mover, the circuit board including a first electrode plate and two second electrode plates, the first electrode plate and the second electrode plates being connected to a detection circuit;
a first floating electrode plate on the first mover, the first floating electrode plate including a first part and a second part electrically connected to each other, the first part being on a first sidewall of the first mover and forming a first sub-capacitor with the first electrode plate, the second part being on a bottom surface of the first mover;
a second floating electrode plate on the second mover, the second floating electrode plate including a fourth part and a fifth part electrically connected to each other, both the fourth part and the fifth part being on a bottom surface of the second mover, the fourth part forming a second sub-capacitor with the second part; and
two third floating electrode plates on the first mover, each of the two third floating electrode plates including a seventh part and an eighth part electrically connected to each other, the seventh part being on a second sidewall of the first mover, the eighth part being on the bottom surface of the first mover, the eighth part of any one of the two third floating electrode plates forming a third sub-capacitor with the fifth part, the seventh parts of the two third floating electrode plates forming two fourth sub-capacitors with the two second electrode plates, respectively;
wherein the first sub-capacitor, the second sub-capacitor, the third sub-capacitor, and the corresponding fourth sub-capacitor are connected in series to provide a capacitance between the first electrode plate and a respective one of the two second electrode plates, and during reciprocating movement of the second mover relative to the first mover along the second direction, capacitance values of the first sub-capacitor, the second sub-capacitor, and the fourth sub-capacitors remain constant, while a capacitance value of the third sub-capacitor varies accordingly.

2. The image stabilization motor according to claim 1, wherein a length of the first electrode plate along the third direction is greater than a length of the first part along the third direction.

3. The image stabilization motor according to claim 1, wherein
an orthographic projection of the second part onto the bottom surface of the base covers
an orthographic projection of the fourth part onto the bottom surface of the base; or,
the orthographic projection of the fourth part onto the bottom surface of the base covers
the orthographic projection of the second part onto the bottom surface of the base.

4. The image stabilization motor according to claim 1, wherein the eighth parts of the two third floating electrode plates are arranged along the second direction.

5. The image stabilization motor according to claim 1, wherein
the circuit board further includes two third electrode plates connected to the detection circuit;
the second floating electrode plate further includes a sixth part electrically connected to the fourth part and the fifth part, the sixth part being on the bottom surface of the second mover;
the image stabilization motor further includes
two fourth floating electrode plates on the first mover, each of the two fourth floating electrode plates including a ninth part and a tenth part electrically connected to each other, the ninth part being on the second sidewall of the first mover, the tenth part being on the bottom surface of the first mover, the tenth part of any one of the two fourth floating electrode plates forming a fifth sub-capacitor with the sixth part, the ninth parts of the two fourth floating electrode plates forming two sixth sub-capacitors with the two third electrode plates, respectively;
wherein the first sub-capacitor, the second sub-capacitor, the fifth sub-capacitor, and the corresponding sixth sub-capacitor are connected in series to provide a capacitance between the first electrode plate and a respective one of the two third electrode plates, and during reciprocating movement of the second mover relative to the first mover along the first direction, capacitance values of the first sub-capacitor, the second sub-capacitor, and the sixth sub-capacitors remain constant, while a capacitance value of the fifth sub-capacitor varies accordingly.

6. The image stabilization motor according to claim 5, wherein the tenth parts of the two fourth floating electrode plates are arranged along the first direction.

7. The image stabilization motor according to claim 5, wherein the two second electrode plates are on a surface of the circuit board along the first direction, and the two third electrode plates are on a surface of the circuit board along the second direction.

8. The image stabilization motor according to claim 1, wherein
the circuit board further includes two fourth electrode plates connected to the detection circuit;
the first floating electrode plate further includes a third part electrically connected to the first part and the second part, the third part being on the first sidewall of the first mover, the third part forming a seventh sub-capacitor with any one of the two fourth electrode plates; and
wherein the first sub-capacitor, and the corresponding seventh sub-capacitor are connected in series to provide a capacitance between the first electrode plate and a respective one of the two fourth electrode plates, and during reciprocating movement of the first mover relative to the base along the third direction, the capacitance value of the first sub-capacitor remains constant, while a capacitance value of the seventh sub-capacitor varies accordingly.

9. The image stabilization motor according to claim 8, wherein along the third direction, a width of each of the two fourth electrode plates is less than or equal to a width of the third part.

10. The image stabilization motor according to claim 8, wherein along the third direction, a spacing between the two fourth electrode plates is less than a width of the third part.

11. The image stabilization motor according to claim 9, wherein along the third direction, a spacing between the two fourth electrode plates is less than a width of the third part.
